(19) United States
(12) Patent Application Publication
(10) Pub. No.: US 2015/0053626 A1
(43) Pub. Date: Feb. 26, 2015

(54) WATER FILTRATION AND TREATMENT SYSTEMS AND METHODS

(71) Applicant: PristineHydro Development, Inc., Laguna Woods, CA (US)

(72) Inventors: Glen B. Caulkins, Laguna Woods, CA (US); Michael H. Colburn, Vista, CA (US)

(21) Appl. No.: 14/532,722

(22) Filed: Nov. 4, 2014

Related U.S. Application Data
(63) Continuation of application No. 13/712,581, filed on Dec. 12, 2012.

(51) Int. Cl. C02F 9/00; C02F 1/68; C02F 1/32; C02F 1/34

(52) U.S. Cl. CPC C02F 9/00; C02F 1/34; C02F 1/68; C02F 1/32; C02F 2103/04
USPC 210/766; 210/198.1; 210/177; 210/178; 210/749

(57) ABSTRACT

Implementations of the present invention relate to systems, methods, and apparatus for filtering and treating water, such as tap water, well water, spring water, etc., and producing drinking, bathing, and swimming water. More specifically, such systems, methods, and apparatus can produce purified water by removing substantially all suspended as well as dissolved solids, undesirable acids, gasses and all and any contaminates from the water. Additionally, the systems, methods, and apparatus can produce reprogrammed high biophoton mineralized drinking water by chilling vortexing over proprietary lodestones, ingenious, sedimentary and metamorphic rocks and creating bicarbonate ions in the water introducing minerals and/or salts into the water.

### CROSS-REFERENCE TO RELATED APPLICATIONS

This patent application is a continuation of U.S. Ser. No. 13/712,581 filed Dec. 12, 2012, which patent application is incorporated herein by specific reference in its entirety.

### BACKGROUND

1. Technical Field

This invention relates to systems, methods, and apparatus for filtering, treating water, purifying, mineralizing, restructuring, and/or reenergizing water.

2. Background and Relevant Art

Although there are various hydration options, some consumers prefer drinking, bathing, and swimming in uncontaminated pristine water. Furthermore, water is frequently used in food preparation and can be an essential ingredient in a meal. There are several common sources for water, and many sources for polluting water. For example, air pollution can cause water pollution. Often, water is polluted before in comes in contact with contaminates found in our environment (e.g., contaminates in the ground). For example, water can be drawn from an aquifer; however, the aquifer can be contaminated from the pesticides sprayed onto the earth and from acid rain that has contaminated the water table. In some instances, acquiring water from the aquifer may require a well and related pumping and, at times, filtration equipment. Conversely, at locations where an aquifer intersects the ground surface, rising or clean or contaminated spring water may be acquired at the surface level.

As water (e.g., acidic water) enters and/or passes through the aquifer, various minerals can be exponentially dissolved in the water, which can make hard water that can affect the taste, smell, and other qualities of the water. Thus, for instance, depending on the location of the aquifer, absent filtration and conditioning, the water drawn from one aquifer may have a different taste than the water drawn from another aquifer. Additionally, in some instances hard water can cause serious health problems for consumers.

In rural areas, consumers frequently draw their water directly from an aquifer, which may be available near their dwellings or places of business. Drawing water directly from an aquifer is relatively uncommon for consumers in urban settings. Typically, urban consumers can obtain drinking water from a supplier or can use tap or municipal water (which at times may be filtered or otherwise treated by the consumer).

Whether obtained directly from an aquifer or from a municipality, the water may have various substances that can make the water unpleasant and/or dangerous or unsuitable for consumption. For example, well or aquifer water can contain various dangerous acids, inorganic minerals, pesticides, contaminants and/or microorganisms. By contrast, municipal water, although less likely to contain microorganisms that may be found in the aquifer, typically includes chemicals used by the municipality for treating the water before distribution. For instance, municipalities often add Chlorine and Fluoride to the water. Although some people think chemical treatment of the water may be beneficial, the chemicals used to treat the water affect our health.

There are a number of ways tap water is usually filtered to remove excess minerals, disinfection byproducts, fluoride, chemicals, pharmaceuticals, or the like to provide the consumer with drinking water that has an improved taste. Normally, however, such filtration removes some or most of the beneficial minerals from the water. Furthermore, the filtration may not remove the carbonic, sulfuric and nitric acids from acid rain, properly mineralize, restructure, and reenergize the water. Moreover, filtered and treated acidic water without proper bicarbonate salts, may not have the taste or smell of contaminated water, which may be desirable by some consumers, however such water may not be conducive to good health.

Accordingly, there are a number of disadvantages in water filtration, treatment, and/or conditioning systems and methods that can be addressed.

### BRIEF SUMMARY OF THE INVENTION

Implementations of the present invention provide systems, methods, and apparatus for filtering and treating stock water (e.g., tap water, well water, spring water, etc.) to produce pristine drinking, bathing, and swimming water. More specifically, such systems, methods, and apparatus can produce purified water by removing substantially all acids, suspended as well as dissolved solids and gasses from the stock water. Thus, the purification treatment process can produce substantially pure water. The substantially pure water can have various uses, such as in laboratories and in various assays, or the like.

In one embodiment, the substantially pure water may not be suitable for human consumption. The substantially pure water may not be safe to drink because it has not been stabilized, mineralized, structured, and/or reenergized. However, the substantially pure water can be free of acids, chemicals, prescription medicines, offensive odors, unpleasant taste, or the like.

In one embodiment, the substantially pure water may be further processes so as to be stabilized, mineralized, structured, and/or reenergized prior to consumption. At least one embodiment includes a water purification system for purifying working water. Such system can have an inlet point configured to transmit working water into the system. The system also can have a first reverse osmosis device in fluid communication with the inlet point. The first reverse osmosis device can have one or more reverse osmosis membranes. Additionally, the first reverse osmosis device can be configured to remove at least a portion of dissolved solids from the working water and to discharge a portion of the working water as drain water. The system also can include an injector in fluid communication with the first osmosis device. The injector can be configured to receive the drain water from the first osmosis device and to discharge the drain water therethrough. The injector can be further configured to create a partial vacuum at a mixture inlet port thereof. Moreover, the system can include a degasification device in fluid communication with the first reverse osmosis device. The degasification device can be configured to receive the working water from the first reverse osmosis device and to separate CO₂ and other gasses there from the water. Additionally, the degasification device can be in fluid communication with the mixture inlet port of the injector. Also, the partial vacuum created by the injector can aid the degasification device to separate the CO₂ and other gasses from the working water.

In one embodiment, the system can include deionization resins. The deionization resins can be useful to remove acids and other unwanted contaminates in the water.

In one embodiment, the system can be configured to use a pump to degas the water. For example, a pump in the system can degas the water. As such, the degasification device may be omitted when a suitable pump is configured for degassing the water, such as a degassing pump.

Because this water is pure H₂O (e.g., no ions in it), it may ionize itself. Therefore, the system can be configured to stabilize the water with suitable ions. In one embodiment, the system includes a magnesium cartridge to add ions to the water so it will not readily ionize itself, with carbon dioxide and create carbonic acid water. The magnesium cartridge can be configured to add magnesium ions to the water so it will not continually ionize itself with carbon dioxide, which creates carbonic acid. The magnesium cartridge can be configured to stabilize the water.

One or more embodiments also include a water conditioning, mineralization, and re-mineralization system for producing mineralized water. Such a system can have a primary holding tank that circulates the magnesium water, and it can contain ingenious, sedimentary, and metamorphic rock configurations, which can include lodestones, crystals and other rocks.

In one embodiment, the system can include a water chiller that is configured to chill the water to get water that is relatively denser than regular room temperature water. For example, water is at its densest state at 4 degree Celsius. This can help rid the water of trauma recording and reprogram water molecules.

In one embodiment, the system can also have a carbonator tank configured to receive purified water and/or purified magnesium water from the chilled primary holding tank and to introduce a controlled amount of CO₂ into the purified water, thereby forming trace amounts of carbonic acid in the alkaline water (i.e., carbonic acid water).

The system also can have a secondary mineralization tank in fluid communication with the primary holding tank and the carbonator. The secondary tank can be configured as a vortex tank, and it can also be configured to receive the purified water (e.g., alkaline magnesium with trace amounts of carbonic acid) from the primary holding tank and carbonator injector.

In one aspect, there is no chiller in the secondary tank. Carbonic acid is stable at 4 degree Celsius, and, as the carbonic acid warms up in the secondary vortex tank, which is an alkaline solution, the carbonic acid dissociates a hydrogen ion and it becomes bicarbonate ions. Bicarbonate ions can form in an alkaline solution.

Additionally, the system can have one or more stones (e.g., ingenious, sedimentary, and metamorphic rocks) containing minerals, the one or more stone being located in the secondary tank, which can be configured as a vortex energizing tank. Furthermore, the vortex tank can be configured to pass the chilled magnesium water with trace amounts of carbonic acid over or through lodestones, crystals and other ingenious, sedimentary and metamorphic rocks, where it warms up, thereby forming a first properly charged bicarbonate water. Lodestones are natural magnets and they posses the same energy as the telluric currents (e.g., earth currents) in the earth—magneto electric. Lodestones in conjunction with crystals and igneous rock positively charge protons, negatively charge electrons, and magnetize hydrogen and neutrons—high biophoton pristine water.

Biophotons are photons of light (e.g., energy) emitted from a biological system. For living organisms, the key reference point on the biophoton energy scale is bound at 6,500 biophoton energy units. From 0 to 6,500 biophoton, the charge is in the negative range, or life-detracting; while above the 6,500 biophoton point, the energy gradually becomes more positive, or life-enhancing. Water chilled (to make it denser) and vortexed over lodestones (DC telluric currents from the earth), crystals and other ingenious, sedimentary, and metamorphic rocks in accordance with the processes of the invention can be reprogrammed or revitalized into high biophoton water (e.g., over 6,500) This will reduce the low energy & negative information that inundates the body from typical water. Telluric currents, bicarbonate ions, minerals, and biophotons (natural light energy) interact to create pristine high-biophoton drinking water under the present invention.

Another embodiment includes a method of purifying, conditioning, and re-mineralizing a working water to create a high biophoton mineralized water. The method can include removing substantially all suspended solids, acids, and gasses from the working water and removing substantially all dissolved solids from the working water, thereby producing pure H₂O, which is then stabilized with magnesium. The method also can include adding CO₂ to the magnesium stabilized water, thereby forming a chilled purified alkaline water with trace amounts of carbonic acid. Moreover, the method can include vortexing the purified magnesium water with trace amounts of carbonic acid over or through stones in the secondary tank, where it warms up. The water now contains high biophoton water molecules and magnesium bicarbonate ions.

In one embodiment, the secondary vortex tank is connected to, a vacuum line at the output line on the vortex pump. The vacuum line is connected to an oxygen generator. The oxygen generator infuses primarily oxygen with trace amounts of carbon dioxide into the water, which can saturate the alkaline magnesium water with oxygen and trace amounts of carbon dioxide to create bicarbonate ions. If the bicarbonate ions in the water are insufficient, the system can turn on the carbonator and add additional carbon dioxide to the alkaline magnesium water and create bicarbonates.

In the final stage prior to dispensing the water, the system can introduce a mineral blend of calcium carbonate, magnesium hydroxide, and sodium and potassium bicarbonates. In one aspect, the mineral blend can be injected from—a chemical injector (e.g., Doseatron injector). In one aspect, the injector can be a vortexing mineral injector, which contains stones having the mineral blend. As such, the mineral blend can be injected into the purified magnesium bicarbonate water, which creates high biophoton, properly mineralized, and energized pristine water that contains four bicarbonate salts (i.e., calcium, magnesium, sodium, and potassium). Bicarbonate ions are negatively charged and can have a strong affinity for the calcium carbonate and magnesium hydroxide. This union creates calcium and magnesium bicarbonate salts, which can be found in liquid form.

Additional features and advantages of exemplary implementations of the invention will be set forth in the description which follows, and in part will be obvious from the description, or may be learned by the practice of such exemplary implementations. The features and advantages of such implementations may be pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. For better understanding, the like elements have been designated by like reference numbers throughout the various accompanying figures. Understanding that these drawings depict only typical embodiments of the invention and are not therefore to be considered to be limiting of its scope, the invention will be described and explained with additional specificity and detail through the use of the accompanying drawings in which:

FIG. 1 illustrates a piping and instrumentation diagram of a water purification and/or filtration system in accordance with one implementation of the present invention;

FIG. 2 illustrates a piping and instrumentation diagram of a water purification and/or filtration system in accordance with another implementation of the present invention;

FIG. 3 illustrates a piping and instrumentation diagram of a water re-mineralization and/or conditioning system in accordance with one implementation of the present invention;

FIG. 4 illustrates a piping and instrumentation diagram of a water conditioning system in accordance with one implementation of the present invention;

FIG. 5 illustrates a flowchart of a water filtration and/or purification process in accordance with one implementation of the present invention; and

FIG. 6 illustrates a flowchart of a water re-mineralization and/or conditioning process in accordance with one implementation of the present invention.

FIG. 7A illustrates an embodiment of a portion of a water production system that is configured for installation under a counter.

FIG. 7B illustrates an embodiment of a portion of a water production system that is configured for installation on a counter top and operably coupled with the portion from FIG. 7A.

### DETAILED DESCRIPTION OF THE PREFERRED EMBODIMENTS

Implementations of the present invention provide systems, methods, and apparatus for filtering and treating stock water (e.g., tap water, well water, spring water, etc.) to produce drinking, bathing and swimming water, or water for any type of use. More specifically, such systems, methods, and apparatus can produce purified water by removing substantially all suspended, acids, liquids, and gasses, as well as dissolved solids from the stock water. Thus, the purification treatment process can produce substantially pure water, which may not be safe to drink because there are no minerals in the water, however it is free of offensive odors and/or unpleasant taste. For example, this purified water without minerals can be useful for laboratories, such as in various biological or chemical assays or experiments.

Furthermore, it should be noted that the system can process essentially any stock water. Specifically, the system can process municipal or tap water and can remove chemicals introduced into such water during treatment at water distribution facilities, acids (e.g., acid rain, sulfuric and nitric acids, etc.), as well as any additional particulate or dissolved solids (whether existing after municipal processing or picked up during transmission through the municipal water distribution system). Likewise, the system can accept and process any other types of water, such as well or spring water from an aquifer.

Moreover, the system and/or method can be scaled to process a desired quantity of water and/or to maintain a desired rate of processing. Thus, the system and method can be equally suitable for a commercial water processing and purification operation as for residential use. Additionally or alternatively, the system and method can be used in an urban environment (e.g., to process tap water) and in a rural environment, which may require processing well or spring water.

After the purification process, the purified water can be properly mineralized and structured before consumption. After the stock water is purified and substantially all of the acids, gasses, particulate and dissolved solids have been removed, the purified water may have no significantly discernible taste and it lacks all of the beneficial minerals that may be present before purification. This purified water, however, can be useful in biological and chemical experiments, such as use as a pure water chemical reagent for a chemical reaction. Accordingly, in one embodiment, the system and method can reintroduce particularly desirable minerals into the purified water. Thus, the system and methods can produce high biophoton re-mineralized drinking water that can have desirable palatability as well as health-promoting qualities. As used herein, the term “drinking water,” generally refers to water that has been properly processed and is ready for consumption.

Moreover, in some embodiments, introduction and reintroduction of a blend of minerals into the purified water (i.e., mineralization or re-mineralization) can produce taste and other beneficial qualities of the mineralized water found in nature. Thus, for example, the system and method can introduce the minerals in a manner that produces drinking water that has a taste similar to natural spring water. Furthermore, such taste can be consistently replicated by the system and method. At the same time, as noted above, the system can remove harmful and/or undesirable particulates, liquids, and/or gasses from the stock water. Consequently, the system and method can produce drinking water that contains an optimized amount of beneficial bicarbonate salts, minerals and elements, while being substantially free of all other (e.g., non-beneficial and/or harmful) substances.

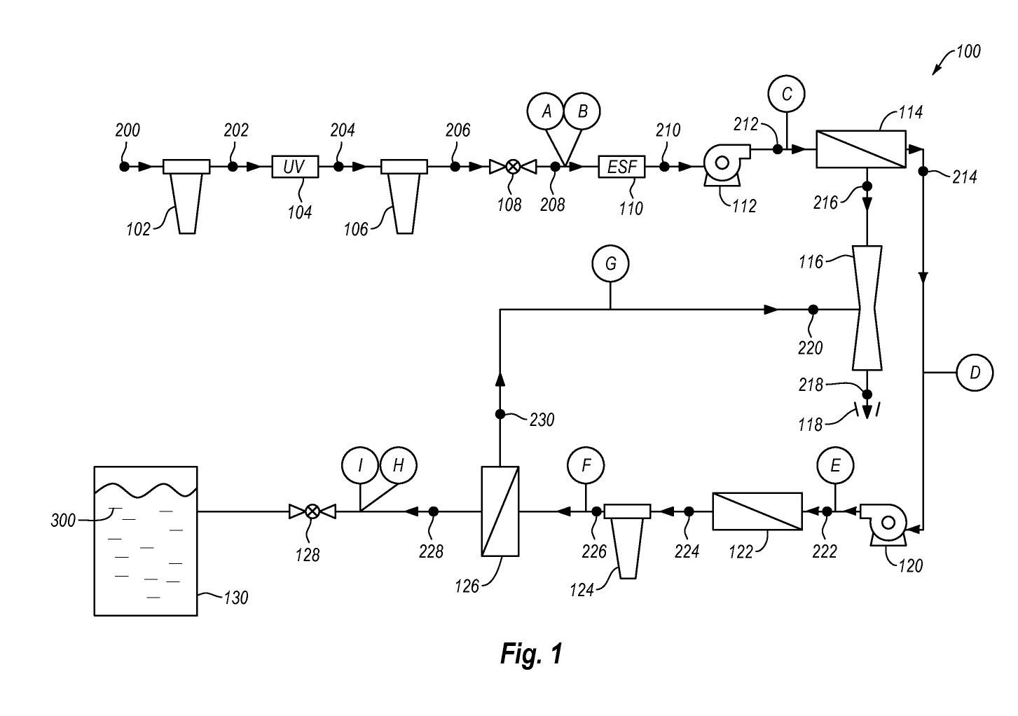

Accordingly, the system can receive stock water and can produce purified and/or mineralize or re-mineralized high biophoton drinking water. An exemplar water purification system 100 is illustrated in FIG. 1. Starting at an inlet point 200, stock water enters the water purification system 100. As described above, the stock water may be municipal or tap water, well water, spring water, etc. In any event, the water purification system 100 can be adjusted to process and purify essentially any type of stock water.

Subsequently, working water enters (or is forced through) a first filter 102. As used herein, the term “working water” refers to the water located in the water purification system 100, before the purification has been completed. Additionally, various components of the water purification system 100 described herein may be connected by standard connecting elements, such as pipes or similar conduits, which can transmit the working water downstream, from one component of the water purification system 100 to another. Likewise, the water purification system 100 can be connected to a water source (e.g., at the inlet point 200) with similar connecting elements.

The first filter 102 can vary from one embodiment to another. Generally, the first filter 102 can provide initial screening (i.e., preliminary filtration) of the working water. Particularly, the first filter 102 can capture particles and solids suspended in the working water. For example, the first filter 102 can be nano-ceramic filter. In one embodiment, the nano-ceramic first filter 102 can remove substantially all suspended particles and solids, as small as 0.02 μm (e.g., by removing 99.99% of suspended particles).

In some instances, the water purification system 100 may require a pump to force the working water through the first filter 102. Typical water pressure of available municipal water, however, may be sufficient to force the working water through the first filter 102. The working water exits the first filter 102 at a point 202. At the point 202, the working water has been substantially cleared of all small particles and solids.

Subsequently, the working water enters a UV treatment unit 104. The UV treatment unit 104 irradiates the working water by exposing the working water to ultraviolet light in order to kill any bacteria, viruses, and similar microorganisms that may be present in the working water. As mentioned above, the stock water entering the water purification system 100 may be municipal, well, spring, or other type of available water. Although some microorganisms may be removed by the first filter 102, in some instances, the stock water and, consequently, the working water at the point 202 also can have various microorganisms, which may be harmful to humans.

The UV treatment unit 104 can expose the working water to ultraviolet light, such as ultraviolet C (UVC) light, in the range of 280-100 nm (e.g., 254 nm). In light of this disclosure, it should be apparent to those skilled in the art that the intensity of the UVC light produced by the UV treatment unit 104 can be adjusted based on the flow rate of the working water, in order to accommodate sufficient treatment of the working water. Thus, the working water can exit the UV treatment unit 104 at a point 204, being substantially clear of all live bacterial and viral entities as well as other microorganisms.

Reducing the number of living microorganisms in the working water also can reduce potential for contaminating various components of the water purification system 100 with living microorganisms. Furthermore, such reduction also can aid in preventing growth (e.g., bacterial growth, biofilm formation, etc.) within the various components. Particularly, in the event bacteria is captured in a subsequent component, such as a filter, as the captured bacteria is less likely to be living, there may be a lower probability of contaminating such component with further bacterial growth.

Thereafter, the working water can enter a second filter 106 for additional filtration. More specifically, the second filter 106 can remove some of the solids dissolved in the working water. For instance, the second filter 106 can be a dual filter, combining KDF (Kinetic Degradation Fluxion) media and enhanced or activated carbon. The KDF media can kill algae and fungi as well as remove chlorine, pesticides, organic matter, etc. Thus, the KDF media can reduce level of certain undesirable substances that may be present in the working water.

Similarly, the enhanced or activated carbon media (portion of the second filter 106) can absorb various small molecules from the working water. For example, activated carbon can absorb chlorine and ammonia, thereby removing chlorine and ammonia from the working water. To force the working water through the second filter 106, the water purification system 100 can include a pump, which can increase water pressure at the point 204. In some instances, however, the water pressure of the stock water may be sufficient to force the working water at the point 204 through the second filter 106. In any event, as the water passes through the second filter 106, the KDF together with the activated carbon can reduce the amount of dissolved substances and materials (particularly chlorine and ammonia) in the working water, as compared between the point 204 and a point 206, where the working water exits the second filter 106.

Thus, at the point 206, the water purification system 100 has preliminarily filtered the working water. Thereafter, the working water may pass through a control valve 108. A system controller can operate the control valve 108, allowing or prohibiting further flow of the working water. For example, the control valve 108 can remain closed to permit maintenance, replacements, or service of various components of the water purification system 100 (located downstream from the control valve 108).

Additionally or alternatively, the water purification system 100 can include a first conductivity sensor A, which can provide information to the system controller about conductivity of the working water. By obtaining the conductivity of the working water, the system controller can estimate the quality of the water at a point 208 (after the working water passes through the control valve 108). Namely, the system controller can correlate the conductivity (or resistance) of the working water at the point 208 with an amount of substances dissolved in the working water. It should be appreciated that, subsequently, (as described below) the controller can compare the conductivity between various points along the flow of the working water through the water purification system 100 to determine the percentage of dissolved solids or purity for the working water. In other words, the system controller can estimate the percentage of the dissolved solids that were removed between two or more points in the water purification system 100.

Furthermore, the water purification system 100 can include a pressure sensor B, which can provide a working water pressure reading to the system controller. As the working water passes through the first filter 102 and/or second filter 106, the pressure of the working water may drop below a desired level. Accordingly, the water purification system 100 can include a pump that can increase the pressure of the working water as may be necessary, based on the reading from the pressure sensor B. Hence, the working water can proceed downstream in the water purification system 100 at an appropriate pressure.

When the control valve 108 is in an open position (i.e., when the system controller opens the control valve 108), the working water can flow into a descaling device 110, which can reduce hardness of the working water. Reduction of the hardness can prevent or reduce damage to other components of the water purification system 100. More specifically, hard working water can be particularly harmful and damaging to reverse osmosis (RO) membranes (described below). Consequently, reducing hardness of the working water can increase longevity of the RO membranes.

The particular descaling device 110 can vary from one implementation to another. For example, the water purification system 100 can include an ESF (Enviro Scale Free) descaling device 110, which is commercially available from Dime Water. Additionally or alternatively, the descaling device 110 may include various water softeners that, for example, can remove or sequester calcium and/or magnesium ions, thereby reducing or eliminating hardness of the water. In any event, after passing through the descaling device 110, at a point 210, the working water can have reduced hardness as compared with the point 208.

Subsequently, a first pump 112 can increase the pressure of the working water from the point 210 to a point 212. Furthermore, a pressure sensor C can provide the system controller with the pressure reading of the working water at the point 212. Hence, the system controller can adjust the amount of head provided by the first pump 112 to a desired level. For instance, pressure of the working water at the point 212 can be in the range between approximately 150 and 200 psi.

It should be noted, however, that the desired pressure of the working water at the point 212 can vary from one embodiment to another and can be based on particular requirements of subsequent components (if any) of the water purification system 100. For example, downstream from the point 212, the working water can enter a first reverse osmosis device 114. The first reverse osmosis device 114 can further purify the working water by removing dissolved substances and materials from the working water.

In one embodiment, the first reverse osmosis device 114 can have two RO membranes, which can remove dissolved materials from the water. Specifically, the first and second RO membranes of the first reverse osmosis device 114 can remove approximately 95% to 98% of the dissolved matter from the working water. Thus, the working water that exits the first reverse osmosis device 114 at a point 214 can have about 2% to 5% of dissolved solids, as compared with the working water at point 212. It should be also noted that the number of RO membranes can vary from one embodiment to another. Furthermore, additional membranes can require increased pressure of the working water at the point 212.

As the working water passes through the first reverse osmosis device 114 and dissolved solids are removed therefrom, a portion of the working water is redirected toward a drain. Such drain water can exit the first reverse osmosis device 114 at a point 216. From the point 216, the drain water can flow downstream through an injector 116. A variety of suitable injectors can be used as the injector 116. For example, the water purification system 100 can incorporate a commercially available injector 116, such as an injector sold by MAZZEI (e.g., model No. 283).

The drain water can exit the injector 116 at a point 218 and flows downstream into a first drain 118. Moreover, as the drain water passes through the injector 116, the velocity of the flow increases and the absolute pressure within the injector 116 decreases. The decrease in pressure within injector 116 also leads to a reduction of pressure at mixture inlet port on injector 116, which can create a partial vacuum at a point 220. The water purification system 100 can utilize such reduction of pressure at the point 220 at another section of the purification operation, as further described below.

The working water that exits the first reverse osmosis device 114 at the point 214 (as described above), flows downstream toward a second pump 120. Moreover, the water purification system 100 also can include a second conductivity sensor D. As noted above, the percent of dissolved solids that were removed between the points 208 and 214 can be calculated by comparing conductivity or resistance readings between the first and second sensors A, D. Consequently, the system controller can determine the percentage of removed matter or, conversely, the percentage of the dissolved solids that remain in the working water at the point 214.

As the working water passes through the first reverse osmosis device 114, the pressure of the working water at the point 214 may be insufficient for subsequent components or operations in the water purification system 100. Accordingly, the second pump 120 can increase the pressure of the working water from the pressure at the point 214 to a higher pressure at a point 222, where the working water exits the second pump 120. Moreover, the water purification system 100 can include a pressure sensor E, which can read the pressure of the working water as the working water exits the second pump 120. Thus, the system controller can adjust the head of the second pump 120 in a manner that the working water at the point 222 is at a desired or required pressure.

The water purification system 100 also can include a second reverse osmosis device 122. The second reverse osmosis device 122 can be substantially the same as the first reverse osmosis device 114. Alternatively, the second reverse osmosis device 122 can have fewer RO membranes or more RO membranes than the first reverse osmosis device 114. For example, the second reverse osmosis device 122 can have a single RO membrane. As the working water passes through the second reverse osmosis device 122, the second reverse osmosis device 122 can remove at least a portion of the dissolved solids from the working water. For instance, where the second reverse osmosis device 122 has a single RO membrane, the second reverse osmosis device 122 can remove approximately 95% of the remaining (e.g., 2-5%) dissolved solids from the working water. In other words, the working water that exits the second reverse osmosis device 122 at a point 224 can have approximately 0.1% to 0.25% of remaining dissolved solids as compared with the water at the point 212.

In some embodiments, the water purification system 100 can have a second drain connected to the second reverse osmosis device 122. The second drain can be similar to or the same as the first drain 118, described above. Accordingly, a portion of the working water can exit the second reverse osmosis device 122 as drain water and can flow toward the second drain. Furthermore, the water purification system 100 also can have a valve that can regulate the amount of drain water exiting the second reverse osmosis device 122 and/or entering the second drain. It should be appreciated that, as noted above, the working water passing through the second reverse osmosis device 122 can be 95% to 98% pure. Thus, in some instances, there may be a minimal amount of or no drain water discharged from the second reverse osmosis device 122.

Hence, at the point 224, substantially all of the dissolved solids have been removed from the working water. In some embodiments, however, the water purification system 100 can further purify the working water. For example, the water purification system 100 can include an MBDI (Mixed Bed Deionization) filter 124. Consequently, the working water from the point 224 can enter the MBDI filter 124 for further purification to remove any remaining positive and/or negative ions. The MBDI filter 124 also can serve as a backup filter, for example, in the event the second reverse osmosis device 122 is out of order (e.g., the RO membrane is damaged or clogged), which can allow the water purification system 100 to continue operating. As the working water exits the filter 124 at a point 226, the water purification system 100 can include a sensor that can be any one or more of the sensors described above, which can provide relevant information to the system controller.

In some embodiments, the water purification system 100 can include a first pH sensor F, which can obtain the pH level of the working water at the point 226. The pH level reading can provide additional information about the quality of the working water at the point 226. Such information can aid the system controller to determine proper treatment and/or adjustments to the treatment of the working water, in order to reach a desired purity and/or acidity level for the working water.

The water purification system 100 also can include a degasification device 126 that can incorporate a DGM membrane. More specifically, the working water can enter the degasification device 126 as the working water flows downstream from the point 226. As the working water passes through the degasification device 126, gases (e.g., CO₂) can be removed from the working water by the degasification device 126. Hence, the working water that exits the degasification device 126 at a point 228 can be substantially gasless.

As described above, as the drain water passes through the injector 116, pressure at the point 220 can be reduced. In some embodiments, the injector 116 may be connected to the degasification device 126 (i.e., to the mixture inlet port) in a manner that allows the injector 116 to apply such pressure reduction at the end of the degasification device 126 that expels gas from the working water passing therethrough. Particularly, the degasification device 126 can experience a reduced pressure at a point 230, and such reduction of pressure can pull the expelled gas out of the degasification device 126. Thereafter, the expelled gas can exit through the injector 116, together with the drain water at the point 218.

Absent the reduction of pressure at the points 220, 230 produced by the injector 116, the water purification system 100 may require a vacuum pump to generate sufficient suction at the point 230, which can help separate and remove the gas from the working water passing though the degasification device 126. Furthermore, additional energy may not be required when the drain water passes through the injector 116 and flows toward the point 218. In other words, the water purification system 100 may not require any additional power, as the drain water flows from the point 216 through the injector 116 to the point 218. Hence, the injector 116 can help to recover some of the energy from the flow of the drain water between the points 216 and 218. Particularly, such energy recovery can take the form of a pressure reduction at the points 220 and 230, which can help to separate and remove the gas from the working water passing through the degasification device 126.

The water purification system 100 also can include a pressure sensor G, which can provide the system controller with pressure information at or between the points 220, 230. In other words, the pressure sensor G can determine the amount of vacuum applied to the degasification device 126. Also, in one or more embodiments, the water purification system 100 can have a vacuum pump connected to the degasification device 126, which can provide supplement or substitute pressure reduction to the pressure reduction produced by the injector 116. For instance, when, based on the reading from the pressure sensor G, the system controller determines that the pressure reduction at the degasification device 126 (i.e., at the point 230) is insufficient, the system controller can engage a vacuum pump to reduce the pressure to a desired vacuum level.

In any event, as noted above, the working water at the point 228 can have substantially less gas (e.g., CO₂) compared with the working water at the point 226. Additionally, it should be noted that CO₂, when combined with water, can form carbonic acid (e.g., H₂CO₃). Accordingly, degasification of the working water at the degasification device 126 can reduce acid formation in the working water and can normalize the pH level thereof.

Moreover, the water purification system 100 can have one or more sensors at or near the point 228, which can be any one of the sensors described above (e.g., conductivity sensor, pressure sensor, or pH sensor). Such sensors can provide relevant information to the system controller. For example, the water purification system 100 can incorporate a second pH sensor H, which can provide the system controller with the pH readings of the working water at the point 228. Hence, the system controller can compare the pH readings from the first and second pH sensors F, H, to determine whether the degasification device 126 removed a sufficient amount of gas (e.g., CO₂) from the working water.

The water purification system 100 also can include a third conductivity sensor I, which can provide information about the working water at the point 228. Consequently, the system controller can compare conductivity readings between the first, second, and third sensors A, D, I to ascertain the change in the purity of the working water between the points 208, 214, and 228. Additionally, the water purification system 100 can include a control valve 128. If, for example, the quality of the water as determined by the control system is adequate, the system controller can open the control valve 128 to allow the water to flow from the point 228 into a first reservoir tank 130. Accordingly, the water located in the first reservoir tank 130 can be purified water 300 that has been processed by the water purification system 100 and may have been tested by the above-referenced sensors.

The water purification system 100 also can include a water level sensor that can monitor the level of the purified water 300 in the first reservoir tank 130. Thus, as the level of the purified water 300 reaches a designated mark in the first reservoir tank 130, the system controller can stop further processing. Moreover, as described below, the first reservoir tank 130 can have an outlet that can allow the purified water 300 to flow out of the first reservoir tank 130. In some embodiments, the purified water 300 can flow into a mineralization/re-mineralization portion of the system for further processing. Alternatively, however, the purified water 300 can be dispensed directly from the water purification system 100, as drinking water.

In light of this disclosure, those skilled in the art should appreciate that particular characteristics of the components of the water purification system 100 can vary from one implementation to another, depending on the particular chemistry and contents of the stock water. Moreover, specific description of the components that can be used in the water purification system 100 (or any other system described herein) should not be read as limiting. For example, the first reservoir tank 130 can be a 300 gallon tank. However, those skilled in the art should appreciate that particular capacity of the first reservoir tank 130 can vary from one application or system configuration to another. Similarly, particular specifications of other components also can vary in different embodiments of the systems described herein.

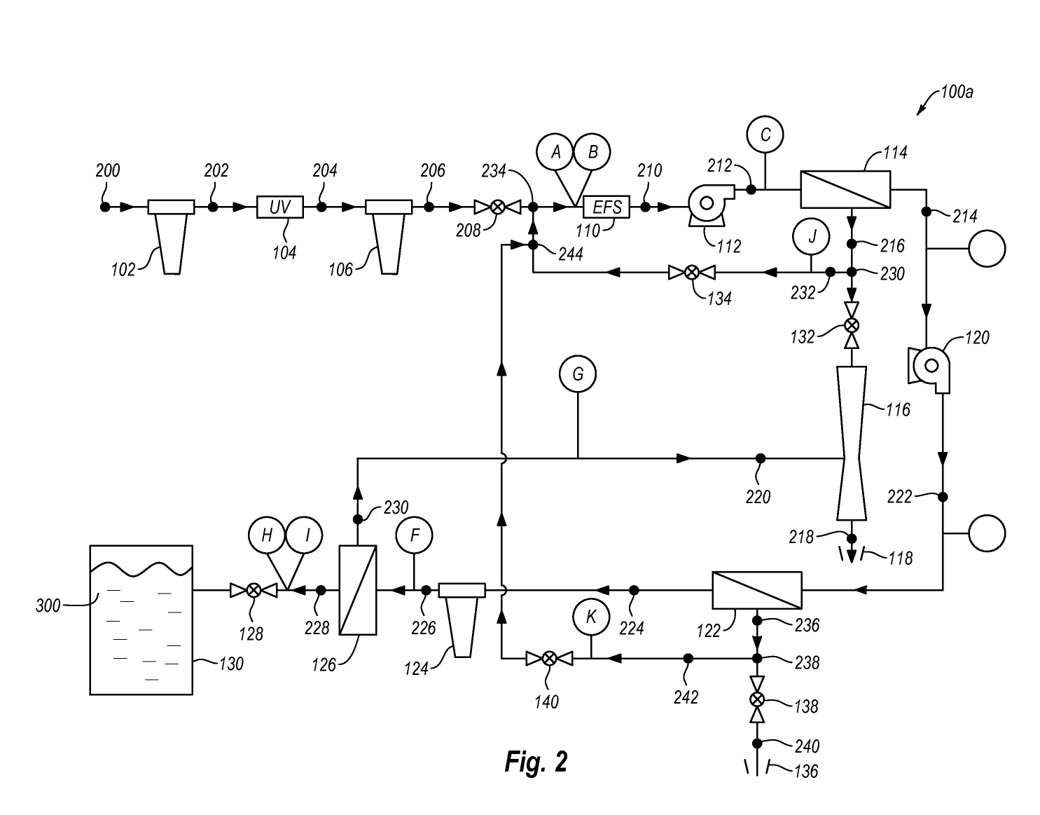

As described above, the water purification system 100 drains a portion of the working water that passes through the first reverse osmosis device 114 and/or the second reverse osmosis device 122 (i.e., the drain water). Moreover, the drain water flows into the first drain 118 and does not otherwise recirculate through the water purification system 100. It should be noted, however, that this disclosure is not so limited. As illustrated in FIG. 2, at least one embodiment includes a water purification system 100a, which can recirculate at least a portion of the drain water. Thus, the water purification system 100a can reduce the amount of stock water that is required for producing a unit of purified water as compared with the water purification system 100. Except as otherwise described herein, the water purification system 100a can be substantially the same as the water purification system 100. Furthermore, the same reference numbers used for identifying various components and points of the water purification system 100 (illustrated in FIG. 1) are used to identify the same or similar components and points of the water purification system 100a, illustrated in FIG. 2.

For instance, as described above, the drain water can exit the first reverse osmosis device 114 at the point 216. Thereafter, the drain water can enter the injector 116 and can proceed to flow along a first drain line to the point 218 and subsequently to the first drain 118. Additionally, the water purification system 100a can include a first drain control valve 132, which can regulate the amount of drain water that enters the injector 116 and subsequently flows into the first drain 118.

At least a portion of the drained water also can flow through a junction point 230 to a point 232 in a first recirculation line. Likewise, the water purification system 100a also can include a first recirculation control valve 134, which can regulate the flow of the drain water through the first recirculation line. Moreover, the water purification system 100a also can include a flow meter J that can provide the system controller information about flow rate of the drain water in the drain line and/or in the first recirculation line. Thus, the system controller can manipulate the first drain and recirculation control valves 132, 134 to adjust the amount of the drain water that flows through each of the first drain and recirculation lines.

As the drained water recirculates back into the system, the drained water can enter the system and can mix with the working water at a point 234. Subsequently, the mixed drain water and the working water form the working water that flows from the point 234 downstream, in the water purification system 100a. Particularly, from the point 234, the working water can flow through the descaling device 110 and exit at the point 210, as described above in connection with the water purification system 100 (FIG. 1).

The first conductivity sensor A can estimate the amount of solids and/or ions dissolved in the working water. Consequently, the first conductivity sensor A can determine the amount of solids dissolved and/or ions in the mixture of the working water with the drained water at the point 234. As the drain water exits the first reverse osmosis device 114, the quantity of dissolved solids in the drain water at the point 216 can be greater than the quantity of solids dissolved in the working water at the point 206.

Accordingly, as drain water is mixed with the working water at the point 234, the quantity of dissolved solids in the working water at the point 234 can be greater than at the point 206. Moreover, the quantity or concentration of solids in the working water at the point 234 can increase with each cycle through the recirculation line, depending on the amount of drain water that recirculates and reenters the system at the point 234. Thus, the system controller can control the amount of drain water that exits through the first drain control valve 132 and the amount of drain water that recirculates back into the system through the first recirculation control valve 134. Particularly, the system controller can optimize the amount of water processed as well as the energy required for such processing.

Additionally or alternatively, similar to the drain water that exits the first reverse osmosis device 114, drain water can exit the second reverse osmosis device 122 at a point 236. Thereafter, the drain water can proceed to flow along a second drain line to a point 240 and subsequently to a second drain 136. Additionally, the water purification system 100a can include a second drain control valve 138, which can regulate the amount of drain water that enters the second drain 136.

In one or more embodiments, the water purification system 100a also can include a second injector that can receive drain water from the second reverse osmosis device 122. Accordingly, additional energy may be recovered from the drain water flowing out of the water purification system 100a. Similar to the injector 116 (described above), the second injector can provide additional reduction of pressure and suction at the point 230, which can assist the degasification device 126 in separating gases from the working water.

In some embodiments, at least a portion of the drain water also can flow through a junction point 238 to a point 242 along a second recirculation line. Likewise, the water purification system 100a also can include a second recirculation control valve 140, which can regulate the flow of the drain water through the second recirculation line. Moreover, the water purification system 100a also can include a flow meter K that can provide the system controller with information about the flow rate of the drain water in the drain line and in the second recirculation line. Thus, the system controller can manipulate the second drain and recirculation control valves 138, 140 to adjust the amount of the drain water that flows through each of the second drain and recirculation lines.

Additionally, the drain water from the second reverse osmosis device 122 can flow through the second recirculation line and can reenter the system at the point 234 (similar to the drain water exiting the first reverse osmosis device 114, described above). Moreover, in some embodiments, the first and second recirculation lines can connect at a point 244. Specifically, at point 244, the portion of the drain water that exits the second reverse osmosis device 122 and flows along the second recirculation line can mix with the portion of the drain water that exits the first reverse osmosis device 114 and flows through the first recirculation line.

Thereafter, the combined flow of drain water can mix with the working water at the point 234, as described above. It should be noted that the drain water exiting the second reverse osmosis device 122 can have a lower concentration of dissolved solids than the drain water exiting the first reverse osmosis device 114. Accordingly, the system controller can allow more drain water to recirculate from the second reverse osmosis device 122 than from the first reverse osmosis device 114. In any event, the control system can adjust the first and second drain and recirculation control valves 132, 134, 138, 140 to provide an optimal amount and concentration of the mixed drain water at the point 244, which will reenter the system at the point 234.

In one embodiment, the system 100 of FIG. 1 and the system 100a of FIG. 2 can include one or more filters between the degasification device 126 and the tank 130. These one or more filters can be at any location between the degasification device 126 and the tank 130. For example, point 228 can include the one or more filters. The one or more filters can be represented by a magnesium filter and/or an enhanced carbon filter. As such, point 228 can include at least one magnesium filter and/or at least one enhanced carbon filter.

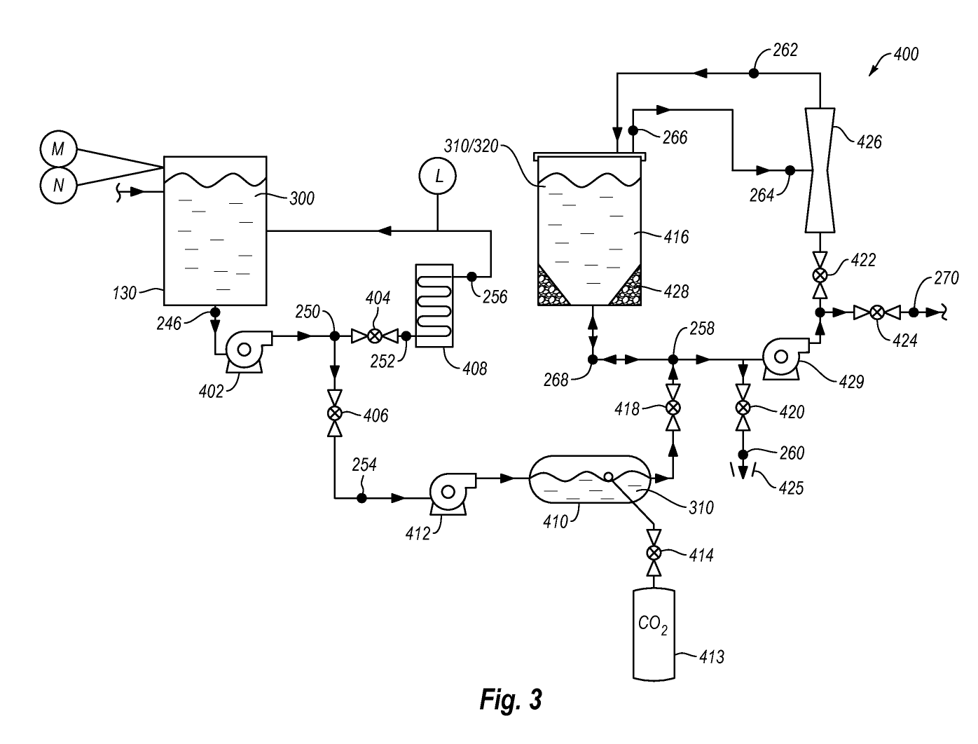

In light of this disclosure, those skilled in the art should appreciate that the recirculation of the drain water from the first reverse osmosis device 114 and from the second reverse osmosis device 122 can be repeated in a closed loop arrangement. Also, similar to the water purification system 100 (FIG. 1) the water purification system 100a can produce purified water 300 that can be stored in and/or dispensed from the first reservoir tank 130. In at least one embodiment, the purified water 300 can proceed to be further conditioned by a water conditioning and/or mineralization/re-mineralization system, which can introduce or reintroduce desirable elements and/or minerals into the purified water 300. Thus, at least one embodiment, as illustrated in FIG. 3, includes a water conditioning system 400.

Particularly, the water conditioning system 400 can process or continue processing the purified water 300 that is located in the first reservoir tank 130. For instance, the purified water 300 can flow from the first reservoir tank 130 to a point 246. In some embodiments, the water conditioning system 400 can include a pump 402 that can force the purified water 300 to flow out of the first reservoir tank 130. Additionally or alternatively, the flow of the purified water 300 from the first reservoir tank 130 can be gravity fed (e.g., the first reservoir tank 130 can be placed at an appropriate elevation that can facilitate such flow). In any event, the purified water 300 can exit the first reservoir tank 130 and flow to the point 246.

Thereafter, the purified water 300 can flow to a junction point 250. In some embodiments, the purified water 300 can flow from the junction point 250 to a point 252 and/or to a point 254. More specifically, the water conditioning system 400 can include first and second transfer valves 404, 406, which can regulate the direction and amount of flow of the purified water 300 from the point 250 to the respective points 252, 254. In other words, the system controller, which may be integrated with the system controller of any one of the water purification systems 100, 100a or may be separate therefrom, can open (partially or fully) the first and second transfer valves 404, 406 to regulate the flow.

For instance, the water conditioning system 400 can include a chiller 408, which can receive and chill the purified water 300. Hence, after the purified water 300 flows to and past the point 252, the purified water 300 can enter the chiller 408, which can lower the temperature of the purified water 300. Thereafter, the purified water 300 can flow out of the chiller 408 to a point 256. It should be understood that the purified water 300 at the point 256 can have a lower temperature than at the point 246.

In one or more embodiments, the water conditioning system 400 can incorporate a temperature sensor L, which can determine whether the temperature of the purified water 300 at the point 256 is appropriate. To the extent that the temperature of the purified water 300 at the point 256 is higher than desirable, the system controller can increase the temperature reduction of the chiller 408. Conversely, to the extent that the temperature of the purified water 300 at the point 256 is lower than desirable, the system controller can decrease the temperature reduction of the chiller 408. Thus, the system controller can optimize the cooling of the purified water 300.

Subsequently, the cooled purified water 300 can reenter the first reservoir tank 130. The cooling process can be run in a closed loop configuration. Accordingly, the purified water 300 located in the first reservoir tank 130 can be cooled to a desired temperature. In one embodiment, the water conditioning system 400 can include a temperature sensor M, which can read the temperature of the purified water 300 in the first reservoir tank 130. As the purified water 300 reaches a desired temperature, the system controller can cease further cooling of the purified water 300, in manner described above. For instance, the first transfer control valve 404 can close, thereby preventing flow of the purified water 300 into the chiller 408.

Additionally, the water conditioning system 400 can include a level sensor N that can provide reading of the level of the purified water 300 in the first reservoir tank 130. In some instance, the purified water 300 can enter the first reservoir tank 130 in a manner described above in connection with water purification systems 100, 100a (FIGS. 1, 2). Thus, the system controller can close a valve that allows the purified water 300 to flow into the first reservoir tank 130, to prevent overflow.

Moreover, the (new) purified water 300 entering the first reservoir tank 130 can be at a temperature that is higher than the purified water 300 that exits the chiller 408 at the point 256. Also, such new purified water 300 can be at a temperature that is higher than a desirable temperature. Thus, as the new purified water 300 mixes with the purified water 300 that is present in the first reservoir tank 130 and/or with the purified water 300 that had passed through the chiller 408, the final temperature in the first reservoir tank 130 can be higher than the desirable temperature. Consequently, the system controller can manipulate the first transfer control valve 404 to produce additional amounts of chilled purified water 300, by passing the purified water 300 through the chiller 408, and thereby maintaining the desirable temperature within the first reservoir tank 130.

In some instances, the desirable temperature can be around 4° C.—i.e., the desirable temperature can be approximately a melt temperature. In other words, the desirable temperature of the purified water 300 in the first reservoir tank 130 can approximate the temperature of the water formed from melting snow or ice. Such desirable temperature also can aid in simulating the conditions of natural water flow into and/or through an aquifer. The chiller 408, however, can reduce the temperature of the purified water 300 below the desirable temperature. For example, the chiller 408 can produce supercool purified water 300, which can be below the desirable temperature (and below the normal freezing temperature of the water). Thus, when the purified water 300 in the first reservoir tank 130 is at the desirable temperature, the purified water 300 at the point 256 can be cooler than the purified water 300 at the point 246 or at the point 250.

It should be also noted that the purified water 300 can flow out of the first reservoir tank 130 at any point (i.e., the point 246 can be located anywhere on the first reservoir tank 130, relative to the outside dimensions thereof). In the embodiment, the purified water 300 can exit the first reservoir tank 130 at the bottom. Thus, the purified water 300 that flows to the point 246 has the lowest temperature (i.e., the coldest purified water 300) within the first reservoir tank 130. Alternatively, however, the purified water 300 can be drawn from other points in the tank to obtain a particular desirable temperature.

As noted above, in some embodiments, the purified water 300 can flow from the point 250 to the point 254 (i.e., when the second transfer control valve 406 is at least partially open). Subsequently, the water conditioning system 400 can reintroduce CO₂ into the purified water 300. Particularly, the water conditioning system 400 can add a desirable amount of CO₂ (e.g., medical grade CO₂) into the purified water 300. Thereafter, the added CO₂ can allow the water conditioning system 400 to add minerals to the water (to form re-mineralized water), which can be in a bicarbonate form.

For example, the purified water 300 can flow into a carbonator tank 410. In some embodiments, the water conditioning system 400 also can include a booster pump 412, which can pump the purified water 300 into and/or through the carbonator tank 410. The water conditioning system 400 also can include a CO₂ tank 413 connected to the carbonator tank 410. As noted above, the CO₂ tank 413 can contain medical grade CO₂, which can be reintroduced into the purified water 300. Particularly, the water conditioning system 400 can have a CO₂ valve 414, which can open to release the CO₂ gas from the CO₂ tank 413 into the carbonator tank 410. The system controller can operate the CO₂ valve 414 to release a desired and/or precise amount of the CO₂ gas into the purified water 300, thereby forming carbonic acid purified water 310. The purified water having the carbonic acid can be referred to herein as carbonic acid purified water 310.

Subsequently, in some embodiments, the carbonic acid purified water 310 can flow out of the carbonator tank 410 and into a first mineralization tank 416. The first mineralization tank 416 can introduce various minerals into the carbonic acid purified water 310, thereby creating a first mineralized drinking water 320. For instance, the first mineralization tank 416 can have minerals and stones 428, such as lodestones, which can supply the desired minerals and elements into the carbonic acid purified water 310 to form the first mineralized drinking water 320.

In at least one embodiment, the water conditioning system 400 also can have a valve 418, which can control entry of the carbonic acid purified water 310 into the first mineralization tank 416. Particularly, the valve 418 can allow or prohibit the carbonic acid purified water 310 to flow to a junction point 258. From the junction point 258 the flow can enter the first mineralization tank 416. Additionally, the water conditioning system 400 can include a drain valve 420, a return valve 422, and a transfer valve 424. The drain valve 420 can open to allow the carbonic acid purified water 310, first mineralized drinking water 320, or a mixture thereof to flow to a point 260 and subsequently to a drain 425.

The return valve 422 can open to allow the carbonic acid water 310, first mineralized drinking water 320, or a mixture thereof to flow into the first mineralization tank 416. The transfer valve 424 can open to allow the carbonic acid purified water 310, first mineralized drinking water 320, or a mixture thereof to flow to another portion or out of the system (as described below). Also, in some instances, the water conditioning system 400 can include a pump 429, which can increase the pressure and facilitate the flow of the carbonic acid purified water 310, first mineralized drinking water 320, and a mixture thereof between the points 258 and 262 and/or 270.

Furthermore, the system controller can manipulate the valve 418, drain valve 420, return valve 422, transfer valve 424, and combinations thereof to control the flow of carbonic acid purified water 310, first mineralized drinking water 320, and mixtures thereof into and out of the first mineralization tank 416. For example, the system controller can close the drain valve 420 and the transfer valve 424, while opening the return valve 422, thereby directing the flow into the first mineralization tank 416. Additionally, closing the valve 418 can allow only the first mineralized drinking water 320 to flow back into the first mineralization tank 416. By contrast, if the valve 418 is open, a mixture of carbonic acid purified water 310 and first mineralized drinking water 320 can flow into the first mineralization tank 416.

In one or more embodiments, the water conditioning system 400 also can include an injector 426. The injector 426 can be similar to or the same as the injector 116 (FIGS. 1, 2). Hence, the carbonic acid purified water 310 and/or first mineralized drinking water 320 can pass through the injector 426, exit at the point 262, and flow into the first mineralization tank 416. For example, the first mineralized drinking water 320 and/or carbonic acid purified water 310 can enter the first mineralization tank 416 at a top thereof (e.g., above the waterline).

While the first mineralized drinking water 320 and carbonic acid purified water 310 remain in the first mineralization tank 416, some of the CO₂ can separate therefrom as gas. The injector 426 can create a reduced pressure at a point 264. Moreover, the CO₂ that separates from the carbonic acid purified water 310 and first mineralized drinking water 320 contained in the first mineralization tank 416 can exit the first mineralization tank 416 at a point 266. Accordingly, the injector 426 can recover at least a portion of the CO₂ that separates from the carbonic acid purified water 310 and/or first mineralized drinking water 320 in the first mineralization tank 416 and reintroduce it into the carbonic acid purified water 310, first mineralized drinking water 320, or a mixture thereof that flows through the injector 426 and into the first mineralization tank 416.

The first mineralized drinking water 320 produced in the first mineralization tank 416 can exit the first mineralization tank 416 at the bottom thereof. Also, the stones 428 can be located at the bottom of the first mineralization tank 416, such that the carbonic acid purified water 310 and/or first mineralized drinking water 320 flows through or about the stones 428.

Particularly, the water conditioning system 400 can create a vortex of the carbonic acid purified water 310 and/or first mineralized drinking water 320 during the exit thereof from the first mineralization tank 416. As such, the carbonic acid purified water 310 and/or first mineralized drinking water 320 can pass through the stones 428 in a more turbulent manner, which can stimulate release of the various minerals and elements from the stones 428 as well as mixing thereof with the carbonic acid purified water 310 and/or first mineralized drinking water 320.

In any event, in at least one embodiment, at a point 268, the water conditioning system 400 can contain the first mineralized drinking water 320. Accordingly, the system controller can close the valve 418 and drain valve 420 and at least partially open the transfer valve 424 to allow the first mineralized drinking water 320 to flow to the point 270. Thereafter, the first mineralized drinking water 320 can flow into another portion of the system, which can store and/or dispense the first mineralized drinking water 320. Additionally or alternatively, the other portion of the system can further process and/or condition the first mineralized drinking water 320, as described below.

In one or more embodiments, the mineralization tank 416 can be initially filled with carbonic acid purified water 310. For example, the valve 418 can be open, while the drain, return, and transfer valves 420, 422, 424 remain closed. Thus, the carbonic acid purified water 310 can flow from the carbonator tank 410, to the point 258, to the point 268, and into the first mineralization tank 416. Once the mineralization tank 416 is filled is filled to a desired level, the valve 418 can close. Also, it should be noted that various combinations and ratios of open/closed valve 418, drain valve 420, return valve 422, and transfer valve 424 can be implemented by the system controller to produce a desired flow of the carbonic acid purified water 310 and/or first mineralized drinking water 320 into and out of the first mineralization tank 416.

In one embodiment, the water conditioning system 400 can include an oxygen generator operably coupled to the first mineralization tank 416 and/or the points 262, 264, 266, 268 and/or the injector 426, or anywhere there between. The oxygen generator can be any known or developed oxygen generator, which can be configured for introducing oxygen into the system 400. Also, the system 400 can include an oxygen sensor at any of these aforementioned locations that can measure the oxygen, and thereby signal a controller to introduce oxygen into the system from the oxygen generator. In one aspect, the oxygen generator can be connected to a fluid flow path that includes a valve (e.g., check valve) and/or an oxygen feed controller that alone or together control the amount of oxygen introduced into the system 400. In one example, the oxygen generator is connected to a valve under control of an oxygen feed controller that ports the oxygen directly into the injector 426. Other variations of combining an oxygen generator for introducing oxygen into the system can be utilized in accordance with the skill in the art.

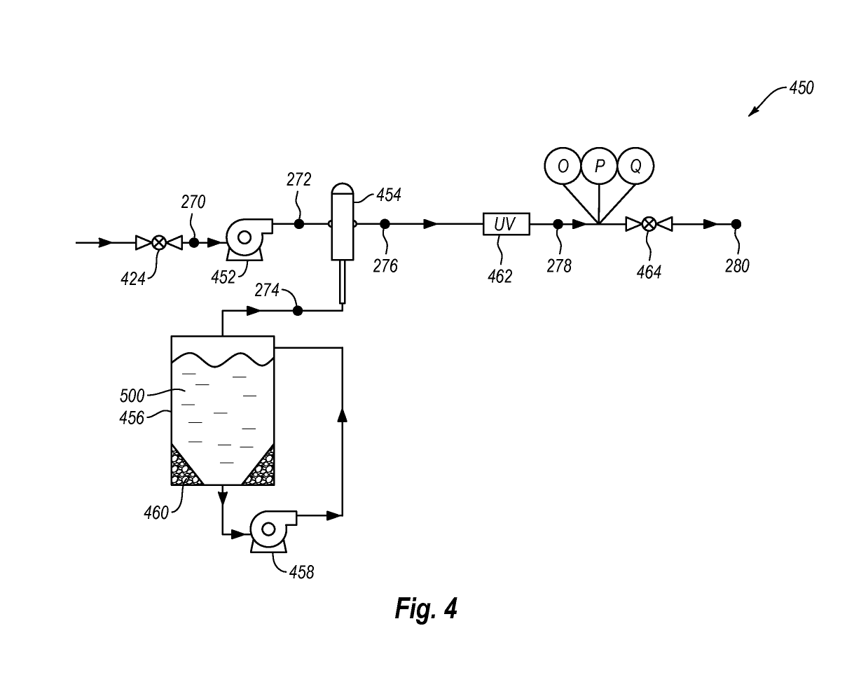

As described above, from the point 270 the first mineralized drinking water 320 can flow to a dispensing device. Additionally or alternatively, the first mineralized drinking water 320 can be further processed in a conditioning system 450, illustrated in FIG. 4. More specifically, the system controller can open the transfer valve 424 and can allow the first mineralized drinking water 320 to flow to the point 270. Thereafter, in some embodiments, the first mineralized drinking water 320 can enter the conditioning system 450.

For instance, the conditioning system 450 can include a pump 452 which can increase the pressure of the first mineralized drinking water between the point 270 and a point 272. The conditioning system 450 also can include a proportional feeder 454. The proportional feeder 454 can be a non-electric proportional feeder, which can create a partial vacuum at a point 274. In some embodiments, the proportional feeder 454 can be the same as or substantially similar to the injector 116 (FIG. 1). In any event, the partial vacuum can draw fluids from a second stage second mineralization tank 456.

For example, the second mineralization tank 456 can contain a salt mixture 500 of natural salts, such as potassium, sodium, calcium, and magnesium. The proportional feeder 454 can draw the salt mixture 500 from the second mineralization tank 456 and mix the salt mixture 500 with the first mineralized drinking water passing through the proportional feeder 454. Thus, the proportional feeder 454 can process the first mineralized drinking water 320 to produce a second mineralized drinking water at a point 276. In some embodiments, the proportional feeder 454 can proportionally mix 0.2% to 2% of salt mixture 500 with the first mineralized drinking water. The proportion of salt mixture 500 mixed with first mineralized drinking water by the proportional feeder 454 also can be greater than 2% or less than 0.2%.

In some embodiments, the conditioning system 450 also can have a pump 458 that can circulate the salt mixture 500 out of the second mineralization tank 456 and back into the second mineralization tank 456. For instance, the second mineralization tank 456, similar to the first mineralization tank 416 (FIG. 3), can have minerals and stones 460 that contain natural salts of potassium, sodium, calcium, and magnesium. The stones 460 can be located on the bottom of the second mineralization tank 456. The pump 458 can drain the salt mixture 500 from the bottom of the second mineralization tank 456, creating a vortex about the stones 460. As noted above, such vortex can incorporate the minerals and elements contained in the stones 460 into the salt mixture 500. Thereafter, the pump 458 can pump the salt mixture 500 back into the second mineralization tank 456. This process can be repeated in a closed loop arrangement, until the desired concentration of the above-noted salts is achieved in the salt mixture 500.

After the salt mixture 500 is mixed with the first mineralized drinking water 320, the second mineralized drinking water can flow to a water dispenser. Alternatively, in one or more embodiments, the second mineralized drinking water can flow from the point 276 into a UV treatment unit 462. The UV treatment unit 462 can kill bacteria, viruses, and other microorganisms that may be present in the second mineralized drinking water. For example, as the purified water is further processed by the water conditioning system 400 and/or conditioning system 450, during certain processes the water may be exposed to air and airborne microorganisms, which may be present in the second mineralized drinking water. Thus, treating the second mineralized drinking water with the UV treatment unit 462 can kill harmful microorganisms that may be therein.

Hence, a final mineralized drinking water exits the UV treatment unit 462 at a point 278. The conditioning system 450 also can include one or more sensors to measure the quality of the final mineralized drinking water at the point 278. For instance, the conditioning system 450 can have a final conductivity sensor O, which can measure the conductivity and/or resistivity of the final mineralized drinking water. Thus, the system controller can obtain an approximate percentage value of dissolved solids in the final mineralized drinking water. Moreover, the system controller can compare the readings of the final conductivity sensor O with the readings of the third conductivity sensor I to determine the quantity of reintroduced minerals or percentage of mineralization of the final mineralized drinking water as compared with the purified water 300 (FIG. 1).

The conditioning system 450 also can have a final pH sensor P, which can read the pH level in the final mineralized drinking water. The final pH sensor P can assure that the final mineralized drinking water has acceptable pH level for dispensing. Furthermore, the conditioning system 450 also can have a dispensing valve 464, which can regulate the flow of the final mineralized drinking water to a point 280. Thereafter, from the point 280, the final mineralized drinking water can be dispensed.

The conditioning system 450 can have a pressure sensor Q, which can assure that the pressure of the final mineralized drinking water at points 278 and/or 280 is adequate for dispensing. A standard water dispensing device, as may be suitable, can connect at the point 280. In any event, at the point 280, the final mineralized drinking water can be ready for dispensing.

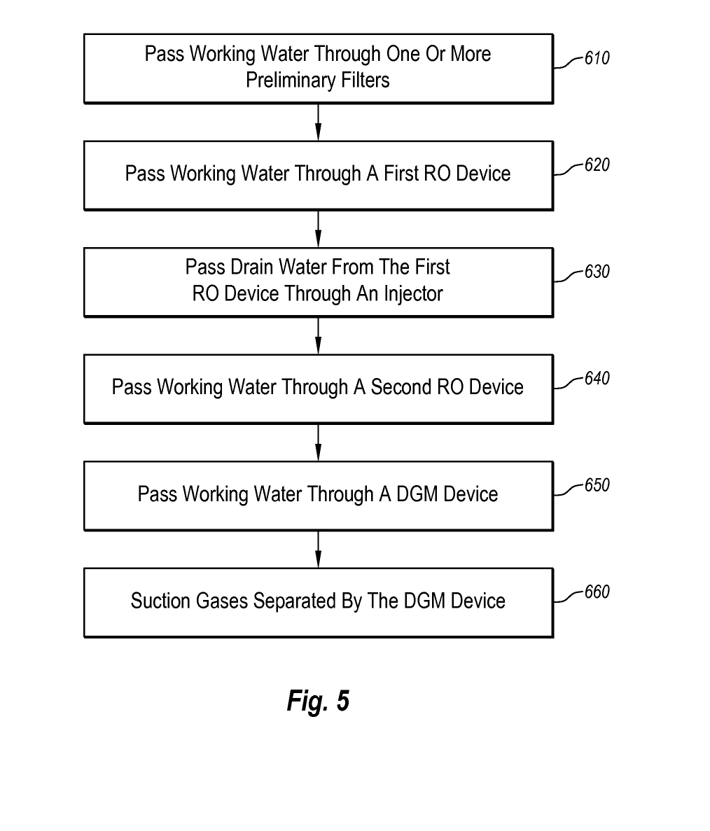

Accordingly, FIGS. 1-4 and the corresponding text, provide a number of different components and mechanisms for purifying, conditioning, treating, and re-mineralizing water. In addition to the foregoing, embodiments also can be described in terms one or more acts in a method for accomplishing a particular result. Particularly, FIG. 5 illustrates a method of water filtration and/or purification process. The acts of FIG. 5 are described below with reference to the components and diagrams of FIGS. 1 through 4.

For example, FIG. 5 shows the method can include an act 610 of passing the working water through one or more preliminary filters. Particularly, as described above, the working water can pass through the first filter 102 and, in some instances, through the second filter 106. Additionally, the working water can pass through the UV treatment unit 104 and/or through the descaling device 110.

The method also can include an act 620 of passing the working water through the first reverse osmosis device, such as the first reverse osmosis device 114. The first reverse osmosis device 114 can include a single or multiple reverse osmosis membranes. Accordingly, in some embodiments, passing the working water through the first reverse osmosis device 114 can be substantially equivalent to passing the working water through multiple reverse osmosis devices.

In one or more embodiments, the method includes an act 630 of passing the drain water out of the first reverse osmosis device through the injector 116. Thereafter, the working water can exit the injector 116 and flow into the first drain 118. Furthermore, the flow of drain water through the injector 116 can reduce pressure at a mixture inlet port of the injector 116. Such reduction of pressure may be used in other acts of the method. In other words, the method can allow recovery of at least a portion of the energy from the drain water, as the drain water flows out of the first reverse osmosis device 114. Also, in some instances, at least a portion of the drain water can recirculate back through the first reverse osmosis device 114.

Additionally, the method can include an act 640 of passing the working water through a subsequent reverse osmosis device, such as the second reverse osmosis device 122. As the working water passes through the second reverse osmosis device 122, a portion of the working water becomes drain water, which can flow into the second drain 136. Also, a portion of the drain water can recirculate through the first reverse osmosis device 114 and/or the second reverse osmosis device 122. For instance, such drain water can first recirculate through the first reverse osmosis device 114 and subsequently through the second reverse osmosis device 122. Moreover, the drain water from the second reverse osmosis device 122 can mix with the drain water from the first reverse osmosis device 114 before recirculating through the first reverse osmosis device 114. Thereafter, the drain water from the second reverse osmosis device 122, first reverse osmosis device 114, and/or a mixture thereof can recirculate through the second reverse osmosis device 122.

The method can further include an act 650 of passing the working water through a degasification membrane (DGM) degasification device 126. In some instance, the working water can pass through the filter 124 before entering the degasification device 126. As the water passes through the degasification device 126, gases separated by the degasification device 126 can be suctioned out of the working water in an act 660. Particularly, as noted above, the pressure reduction created by the injector 116 (in the act 630) can be used to suction the gases. Additionally or alternatively, a vacuum pump can be used to create or increase reduction of pressure required for suctioning the gases in the act 660.

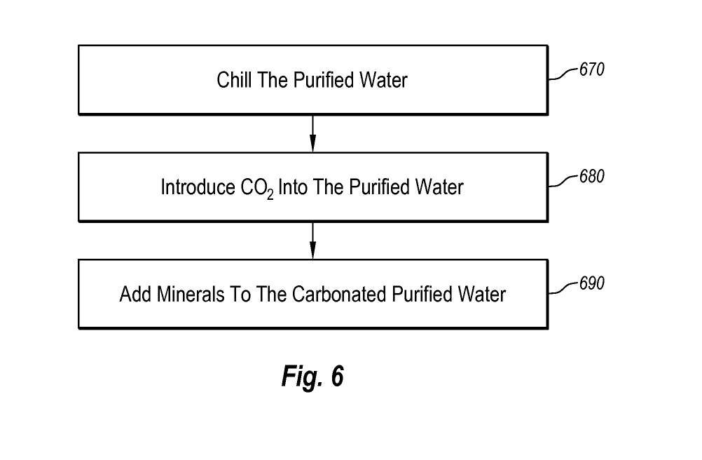

At least one embodiment includes another or a further method of conditioning and/or mineralizing/re-mineralizing water, as illustrated in FIG. 6. The acts of FIG. 6 are described below with reference to the components and diagrams of FIGS. 1 through 4. For example, as illustrated in FIG. 6, such method can include an act 670 of chilling the purified water 300. Particularly, the purified water can circulate out of the first reservoir tank 130, through the chiller 408, and back into the first reservoir tank 130. As the chiller 408 cools the purified water 300 that circulates therethrough, the purified water 300 in the first reservoir tank 130 also will be cooled. For instance, the purified water 300 can be cooled to approximately 4° C.

Additionally, the method can include an act 680 of introducing CO₂ into the purified water 300, thereby producing the carbonic acid purified water 310. In some embodiments, the purified water 300 may be initially cooled (e.g., in the act 670), before the introduction of CO₂. Also, a controlled and precise amount of CO₂ can be added to the purified water 300, thus forming the carbonic acid purified water 310 with a desired concentration of CO₂.

The method may further include an act 690 of adding minerals and/or salts to the carbonic acid purified water 310, thereby forming mineralized drinking water. For example, the carbonic acid purified water 310 can circulate through the first mineralization tank 416, which can have stones 428 therein. Particularly, the stones 428 can be located on the bottom of the first mineralization tank 416, and the carbonic acid purified water 310 can form a vortex upon exiting the first mineralization tank 416, which can aid in dissolving and absorbing the minerals from the stones 428 into the carbonic acid purified water 310, thereby forming the first mineralized drinking water 320.

Moreover, the carbonic acid purified water 310 and/or first mineralized drinking water 320 can receive salts. For example, the carbonic acid purified water 310 or first mineralized drinking water 320 can pass through the proportional feeder 454, which can draw minerals from the second mineralization tank 456. The second mineralization tank 456, in turn, can contain the salt mixture 500. More specifically, in one embodiment, the second mineralization tank 456 can contain alkaline magnesium water (e.g., water that is alkaline and contains magnesium) that can circulate through the minerals and stones 460 thereby forming the salt mixture 500, which can be drawn into the carbonic acid purified water 310 or into the first mineralized drinking water 320 that may pass through the proportional feeder 454.

Thereafter, the mineralized drinking water can be made available through a standard dispensing machine. Additionally, prior to dispensing the mineralized drinking water, the method also can include an act of further sterilizing the mineralized drinking water by passing the mineralized drinking water through the UV treatment unit 462. Accordingly, the mineralized water available for dispensing may contain no or minimal amounts of live microorganisms.

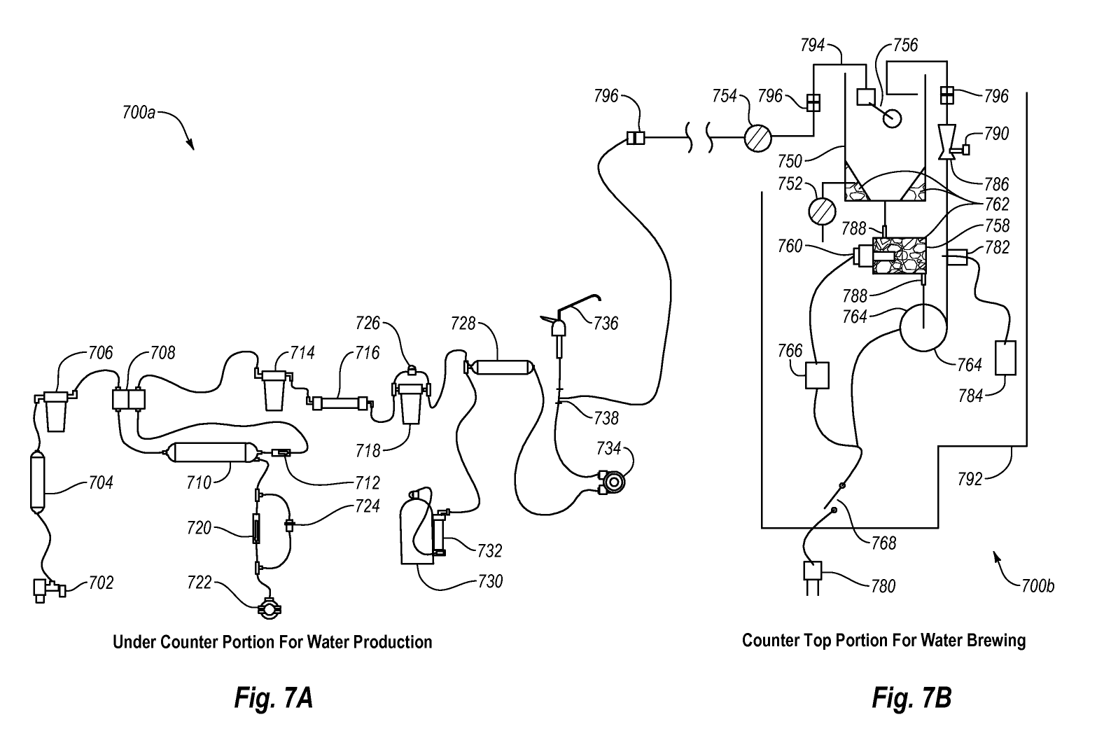

FIG. 7A illustrates an embodiment of a portion of a water production system 700a that is configured for installation under a counter. As shown, the system 700a includes: an adapter 702 that is configured for attachment to a cold side domestic water supply via an assembly that also includes an on/off valve to permit ease of installation and service: a filter 704 that is fluidly coupled to the adapter 702 and filters the water so that no particles in excess of 5 microns in size pass through which could cause premature plugging of membrane 710: a filter 706 which is fluidly connected to filter 704 which contains a metallic based and bio static material such as KDF or one of its substitutes that removes chlorine via a redox reaction that changes the chlorine (a gas) to chloride (a harmless, tasteless, odorless dissolved ion) and has a capacity for this removal approximately 5× that of activated carbon and also a special enhanced activated carbon. By placing the KDF in the filter so that the flow of water is exposed to it first, the resulting water prior to passing through the enhanced activated carbon is void of chlorine thus increasing the potential life of the activated carbon which has as a purpose the removal of chloramines and volatile organics. The resulting extended life of the filter is intended to protect the polyamide rejection material used in element 710 from the deleterious effects of chlorine and remove possibly harmful to health volatile organics such as trichloromethane from the processed water.

Fluidly connected to filter 706 is a shut-off valve 708. This valve is has fluid connections that allow the inlet feed water to pass through it to the remainder of the device until the processed water in the hydro pneumatic RO accumulator tank which also is connected fluidly to the 708 shut off valve reaches a pressure of approximately 80% of the pressure passing through filter 706 at which point the shut off valve 708 ceases the flow of water. The treated and pressurized water from the tank 730 is separated from the untreated water by a flexible elastic diaphragm that prevents mixing of the two qualities of water. In another iteration, valve 708 can be replaced with an electrically operated solenoid valve that would be operated by a pressure switch arranged so that it measured the pressure in tank 730.

Fluidly connected to the water from filter 706 through valve 708 is a cylindrical housing or housings containing the reverse osmosis membrane(s) 710. The water from valve 708 flows axially through the membrane and divides into two paths internally. One path is to drain where the flow and the resulting back pressure is controlled with a capillary tube 720 which is also fluidly connect to a waste drain normally through a fitting on a drain pipe represented by drain clamp 722. The drain flow rate through the capillary tube 720 is normally in the range of 50% of the flow from valve 708 and the user is instructed to periodically open valve 724 to flush accumulated suspended solids that may have been created within the geometry of the membranes.

The other flow from the membrane/housing assembly 710 is referred to as the product water. This water exits the housing through a check valve 712. The product water has been forced through the membrane which is formed by a thin polyamide semi permeable rejection layer supported by a permeable backing material. Such membranes have a porosity in the range of 0.0002 microns. Such small porosity prevents passage of most identified bacteria, viruses and cysts. The water molecule will pass through but through a process of mass transfer 90% or more of the dissolved ions in the water are rejected by the membrane thus remaining in the drain flow and discharged along with any suspended matter through the drain fitting 722. The product flow after the check valve is fluidly connected to the shut-off valve 708 and from there it is fluidly connected to cation resin cartridge filter 714.

Water entering filter 714 is first exposed to a cation resin were all remaining dissolved solids with a positive valence are exchanged for hydrogen ions. The resulting water thus is an accumulation of mineral acids created by hydrogen and the un-removed anions—HCL (Hydrochloric), HNO3(Nitric), H2SO4(sulfuric), HCO3(carbonic), etc. The resulting acid water then passes through a volume of special anion resin. This resin will remove anions thus neutralizing the acids EXCEPT for the mild carbon dioxide portion of the carbonic acid which is desired to produce the desired resulting chemistry of the finished water for the user.

Water exiting filter 714 is fluidly connected to filter 716 which is a duplicate polishing version of filter 714.

Filter 718 is fluidly connected to filter 716 and contains a salt of magnesium. Because water from filter 716 is like water from filter 714 in that it contains mild carbonic acid, the salt is slowly dissolved thus imparting magnesium bicarbonate to the water. This results in an elevated pH and the water is often referred to as alkaline water. Valve 726 fluidly connects the inlet to the outlet of filter 718 permitting the end user to variably control the degree of magnesium bicarbonate in the water. When valve 726 is fully closed all water from filter 716 will pass through filter 718 thus maximizing the concentration. When valve 726 is fully open virtually all water from filter 716 will by-pass filter 718 due to the pressure drop caused by the need for water to pass through the media thus minimizing the presence of magnesium bicarbonate. By carefully adjusting valve 726 the end user is then able obtain a level that meets their requirements.

The outlet of filter 718 is fluidly connected via a hydraulic TEE to the hydro pneumatic storage tank 730 and activated carbon filter 728. If there is no flow demand for use, water from filter 726 will flow to tank 730 where the processed water is pressurized by an air pre-charge within the tank. The water is held in a chemically inert elastomeric bag within the tank thus separating the treated water from the tank material and the air for sanitary safety. On the way into tank 730 the water passes through a container 732 that contains small sedimentary and igneous rocks as well as lode stones to replicate the passage of water within a natural stream. Upon a flow demand caused by the opening of faucet 736 or from the float water valve 756 detailed in FIG. 7B, water will exit tank 730, pass through the mineral contact chamber 732 and enter carbon filter 728 in a flow path reversed from the filling of tank 730. This flow being higher in rate than the fill rate will create an upward vortex flow within the contact chamber 732 where it then enters carbon filter 728 and flows through the carbon to the exit of filter 728. Any taste components given off by the magnesium salt in filter 718 will be removed by the activated carbon.

Filter 728 is fluidly connected to a Hall Effect turbine meter such as item 734 or alternately to a flow sensing magnetic reed switch. Either sensor activates an battery operated electronic signal counter pre-set to a volume of water that gives a signal to the consumer advising that replacement of deionizer cartridge 714 and 716 is required. Three signals are provided—a green light indicating all is well, an amber light indicating 20% of filter life remains and a red light indicating filter life is exhausted.

The outlet of the sensor 734 is fluidly connected to a hydraulic TEE 738 so that either or both faucet 736 or valve 756 when opened will cause water to flow from tank 730, through chamber 732, and through filter 728. If however tank 730 has failed to fill or if extraction of water from faucet 736 or the brewer detailed in FIG. 7B has emptied the tank 730, then water at a very low flow will go directly from filter 718 regardless of the position of by-pass valve 726, through filter 728, indicator 734, and to either or both faucet 736 and float valve 756.

FIG. 7B illustrates an embodiment of a portion of a water production system 700b that is configured for installation on a counter top and operably coupled with the system 700a from FIG. 7A. Fully treated water from the system shown in FIG. 7A, couples to system 7B using a connector device 796 that includes a male and female portion wherein when the male portion is inserted into the female portion, water flows freely. However when separated by the release of a single button pressurized water from the components in FIG. 7A cannot flow and water cannot flow from the system in Fig. B because it is not pressurized. Optionally or in addition to the connector device 796, a manual valve 754 may be employed between the two systems.

The water from the use of either or both items 796 and 754 is fluidly connected to another connector 796 half of which is permanently assembled to the appliance structure 792 of system 700b and delivers water to the holding vessel 750. Vessel 750 can be preferentially constructed of glass or crystal or alternately by a ceramic crock or stainless steel vessel. Water from connector 796 flows through a preferentially stainless steel tube fill line 794 which can be alternately made of plastic, glass or some other inert material. The start and stop of the water flow is controlled by a float valve 756 fluidly connected to the fill line 794.

Once in the vessel 750, which is elevated above the counter surface the entire system 700b rests upon, the treated water may be removed by opening the dispenser valve 752. Alternately, the residing water may be further treated. By activating switch 768 with the power cord 780 plugged into a standard household electrical outlet, re-circulation pump 764 and chiller 760 are activated. The pump receives power directly and the chiller receiving power from transformer 766.

The suction side of pump 764 is fluidly connected to and draws water from the bottom of vessel 750, and between the tank and the pump a chiller chamber 758 is placed. Circulating water passes into and out of chamber 758 via offset hydraulic fittings 788, which are placed to create a vortex action within the chamber of vessel 750. The chamber also contains crystals, lode stones and stones to replicate the flow of water in a natural stream.

The outlet of pump 764 is fluidly connected to a probe 782 with noble metal electrodes. The probes 782 are connected to a battery operated device 784 that measures the conductivity of the water converts the conductivity electronically to a familiar value called Total Dissolved Solids and displays it digitally for the end user. Water leaving the holding probe 782 is fluidly connected to a suction creating injector 786. Water flowing into and out of injector 786 creates a suction that draws air into the water and mixes it well via mass transfer. For sanitary purposes, the air being included passes through a sub-micron filter 790 to remove spores and bacteria.

The outlet of the injector 786 is fluidly connected to a connector 796 half of which is permanently attached to the structure of the appliance 792. The outlet of connector 796 is a tube similar in size and material to fill line 794 and with a geometry where it enters vessel 750 designed to induce a visible vortex within the vessel. Vortexing water contacts more crystals, lode stone and stones 762 to further enhance replicating natural stream water.

The user of the system may add magnesium or other electrolyte salts, vitamins, minerals, flavors and other nutricuticals to the water as it circulates and obtain a close approximation of the level of additives by viewing the meter 784. By using connectors 796, the user may disconnect the feed and re-circulation tubes to facilitate cleaning of vessel 750. Additionally, where vessel 750 joins the appliance structure 792, quick connect tubing can be used to facilitate vessel removal.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. A water conditioning system for producing drinking water, the system comprising:
a mineralization tank having a tank chamber with a water inlet and a water outlet; and
one or more lodestones containing minerals located in the mineralization tank, wherein the first mineralization tank is configured to pass water over or through the lodestones, thereby forming a first mineralized water.

2. The system of claim 1, further comprising a vortexer operably coupled with the mineralization tank so as to vortex the water over or through the lodestones.

3. The system of claim 2, wherein the vortexer is a pump operably coupled to the water outlet, which water outlet is at a bottom of the mineralization tank.

4. The system of claim 3, wherein an outlet from the pump is fluidly coupled to the mineralization tank chamber.

5. The system of claim 1, further comprising a carbonator tank having a carbonator tank outlet that is fluidly coupled with the water inlet of the mineralization tank, the carbonator tank being configured to form carbonic acid water.

6. The system of claim 5, further comprising a carbon gas tank having a carbon gas outlet that is fluidly coupled to a carbon gas inlet of the carbonator tank.

7. The system of claim 6, wherein the carbonator tank is configured to receive water and to introduce a controlled amount of CO₂ into the water from the carbon gas tank, thereby forming the carbonic acid water.

8. The system of claim 5, further comprising a cooling unit with a cooling fluid pathway therethrough, an outlet of the cooling fluid pathway being fluidly coupled with a carbonator tank inlet of the carbonator tank.

9. The system of claim 8, wherein the cooling unit is configured to cool water in the cooling fluid pathway to about 4 degrees Celsius.

10. The system of claim 8, further comprising an injector having a water injector inlet fluidly coupled with the mineralization tank and a water outlet fluidly coupled with the mineralization tank, and having a gas inlet fluidly coupled with a top of the mineralization tank so as to extract gas from the mineralization tank and inject it to water within the injector.

11. The system of claim 8, further comprising:
a second mineralization tank having a second tank chamber with a second water inlet and a second water outlet; and
a second set of one or more lodestones containing minerals located in the second mineralization tank, wherein the second mineralization tank is configured to pass water over or through the second set of one or more lodestones, thereby forming a second mineralized water; and
a mixer fluidly coupled with the water outlet of the mineralization tank and with the second water outlet of the second mineralization tank.

12. The system of claim 11, further comprising a UV treatment unit fluidly coupled to an outlet of the mixer.

13. The system of claim 11, further comprising a water purification system having an outlet fluid pathway upstream and operably coupled with the cooling fluid pathway.

14. A water conditioning system for producing drinking water, the system comprising: a mineralization tank having a tank chamber with a water inlet and a water outlet, and one or more lodestones containing minerals located in the mineralization tank, wherein the first mineralization tank is configured to pass water over or through the lodestones, thereby forming a first mineralized water;
a vortexer operably coupled with the mineralization tank so as to vortex the water over or through the lodestones, wherein the vortexer is a pump operably coupled to the water outlet, which water outlet is at a bottom of the mineralization tank, wherein an outlet from the pump is fluidly coupled to the mineralization tank chamber;
a carbonator tank having a carbonator tank outlet that is fluidly coupled with the water inlet of the mineralization tank, the carbonator tank being configured to form carbonic acid water;
a carbon gas tank having a carbon gas outlet that is fluidly coupled to a carbon gas inlet of the carbonator tank, wherein the carbonator tank is configured to receive water and to introduce a controlled amount of CO₂ into the water from the carbon gas tank, thereby forming the carbonic acid water;
a cooling unit with a cooling fluid pathway therethrough, an outlet of the cooling fluid pathway being fluidly coupled with a carbonator tank inlet of the carbonator tank, wherein the cooling unit is configured to cool water in the cooling fluid pathway to about 4 degrees Celsius; and
an injector having a water injector inlet fluidly coupled with the mineralization tank and a water outlet fluidly coupled with the mineralization tank, and having a gas inlet fluidly coupled with a top of the mineralization tank so as to extract gas from the mineralization tank and inject it to water within the injector.

15. The system of claim 14, further comprising:
a second mineralization tank having a second tank chamber with a second water inlet and a second water outlet; and
a second set of one or more lodestones containing minerals located in the second mineralization tank, wherein the second mineralization tank is configured to pass water over or through the second set of one or more lodestones, thereby forming a second mineralized water; and
a mixer fluidly coupled with the water outlet of the mineralization tank and with the second water outlet of the second mineralization tank.

16. The system of claim 15, further comprising a UV treatment unit fluidly coupled to an outlet of the mixer.

17. A method of mineralizing water, the method comprising:
introducing water into the mineralization chamber of claim 1;
passing the water over or through the one or more lodestones containing minerals located in the mineralization tank to form a first mineralized water.

18. The method of claim 17, comprising vortexing the water over or through the one or more lodestones.

19. A method of conditioning water, the method comprising:
obtaining purified water that is stabilized;
introducing the purified water into the system of claim 14;
chilling the purified water to chilled water;
adding CO₂ to the chilled water, thereby forming trace amounts of carbonic acid in the chilled water to produce bicarbonate water;
vortexing the bicarbonate water over or through one or more lodestones containing one or more minerals to charge water molecules and obtain a mineralized water; and
combining mineralized water with calcium carbonate, magnesium hydroxide, sodium and potassium bicarbonate to produce a first mineralized drinking water.

20. The method of claim 19, wherein the combining mineralized water with calcium carbonate, magnesium hydroxide, sodium and potassium bicarbonate includes obtaining a second water having the calcium carbonate, magnesium hydroxide, sodium and potassium bicarbonate, and mixing the second water with the mineralized water.
